(19) United States
(12) Patent Application Publication
(10) Pub. No.: US 2013/0241865 A1
(43) Pub. Date: Sep. 19, 2013

(54) TOUCH DISPLAY DEVICE AND METHOD FOR DETERMINING TOUCH POSITION THEREOF

(71) Applicants: SHENG-YUAN LIN, New Taipei City (TW); Jui-Hsiang Lo, New Taipei City (TW); Hsueh-Yu Lu, New Taipei City (TW); Huang-Jen Chen, New Taipei City (TW); Chi-Ming Tseng, New Taipei City (TW); Chien-Wei Wang, New Taipei City (TW)

(72) Inventors: SHENG-YUAN LIN, New Taipei City (TW); Jui-Hsiang Lo, New Taipei City (TW); Hsueh-Yu Lu, New Taipei City (TW); Huang-Jen Chen, New Taipei City (TW); Chi-Ming Tseng, New Taipei City (TW); Chien-Wei Wang, New Taipei City (TW)

(73) Assignee: Cheng Uei Precision Industry Co., LTD., New Taipei City (TW)

(21) Appl. No.: 13/424,182

(22) Filed: Mar. 19, 2012

(51) Int. Cl. G06F 3/045

(52) U.S. Cl. 345/174

(57) ABSTRACT

The present invention discloses a touch display device and a touch measuring method for determining touch positions thereof. The touch display device includes a touch sensing module, a substrate, a pressure sensing device disposed between the touch sensing module and the substrate, and an integrating device. The method includes a first position measuring step, a step of sensing an initial pressure, an initial pressure sensing step, a second position measuring step, a real-time pressure sensing step and a data integrating step. The first and second position measuring steps are to measure X-axis and Y-axis coordination values. The real-time pressure sensing step is to sense pressure change between the first and second positions. The data integrating step is to integrate data of the first and second positions and initial and real-time pressure values. The sensed pressure represents a Z-axis position corresponding to X-axis and Y-axis.

### FIELD OF THE INVENTION

The present invention relates to a touch determining method which is adapted to sense and determine touch positions on the touch display device, and in particular to a touch display device and a touch determining method capable of sensing the pressure of the touch positions.

### THE RELATED ARTS

Touch panels can be operated directly by touching, and their applications range increasingly wider, such as small-sized-panel mobile phones, displays for computers or even large-sized-panel monitors, and other consumer electronic devices.

Types of the conventional touch control technology are various, such as the resistive type, the capacitive type, or the optical type, etc. It can determine the touch positions by the touch of fingers or electromagnetic pens so as to execute corresponding functions. Nevertheless, such touch control technology needs not only to control and operate the functions of the products, but also apply in writing or drawing function which is now a main trend for development of the current touch control technology. However, no matter what type of the conventional touch control technology is adopted, it can merely present the two-dimensional characteristic (i.e., X-axis and Y-axis) of the determined touch positions. In other words, the determining methods of the conventional touch control technology can only present lines with a single width rather than present lines with different widths according to the touch positions, i.e., the three-dimensional characteristic (Z-axis) thereof. As a result, the display line performance becomes dull and unexcited, and cannot fulfill the need of applications to line thickness changes presented in text shaping or drawing. Such drawback is always a developing bottleneck of the conventional touch control technology.

### SUMMARY OF THE INVENTION

An objective of the present invention is to provide a touch display device and a touch measuring method for determining touch positions, both of which can sense two dimensional planar touch positions of touched locations and touch pressure thereof as well.

To achieve the above objective, the present invention provides a touch measuring method adapted to sense and determine touch positions of a touch display device. The method comprises a first position measuring step for sensing a first position in a touch area by a touch sensing module to determine X-axis and Y-axis coordination values of the first position, an initial pressure sensing step for sensing an initial pressure of the first position by a pressure sensing device, a second position measuring step for sensing if the first position has moved to a second position and determining X-axis and Y-axis coordination values of the second position by the touch sensing module, a real-time pressure sensing step for sensing a pressure change during movement from the first position to the second position by the pressure sensing module and generating a corresponding pressure value based on the sensed pressure change as an instantaneous pressure, and a data integrating step for integrating data of the first position, the second position, the initial pressure and the instantaneous pressure via an integrating device using a drive circuit and producing aggregated information thereof.

To achieve the above objective, the present invention provides a touch display device comprising a touch sensing module defining a touch area and comprising a touch screen, at least one sensing element, an analog multiplexer and an analog-digital converter wherein the at least one sensing element is used for sensing touch positions within the touch area, a substrate for carrying the touch sensing module, a pressure sensing device installed between the touch sensing module and the substrate and comprising at least one pressure sensing element with an upper contact surface and a lower contact surface to respectively bear touch pressing forces and reaction forces thereof to generate a corresponding pressure value, and an integrating device comprising a drive circuit and electrically coupled to the pressure sensing device and the touch sensing module, and integrating data signals transmitted from the touch sensing module and the pressure sensing device to produce aggregated information.

The touch measuring method for determining touch positions of the present invention in cooperation with the touch display device of the present invention can display diversity in lengths and widths of displayed lines when the aggregated data and information received and integrated by the integrating device of the present invention is displayed graphically by line images so as to meet using needs in writing, text shaping, or drawing.

### BRIEF DESCRIPTION OF THE DRAWINGS

The present invention will be apparent to those skilled in the art by reading the following description of a preferred embodiment of the present invention, with reference to the attached drawings, in which:

FIG. 1 is a schematic basic functional block diagram of a touch display device of the present invention.

FIG. 2 is a basic flowchart diagram of a method for determining touch positions of the present invention.

FIG. 3 is a detailed flowchart diagram of the method for determining touch positions of the present invention.

FIGS. 4A and 4B are schematic cross sectional views of the touch display device according to a first preferred embodiment of the present invention.

FIGS. 5A to 5C are schematic cross sectional views of the touch display device according to a second embodiment of the present invention.

FIGS. 6A to 6C are schematic cross sectional views of the touch display device according to a third embodiment of the present invention.

### DETAILED DESCRIPTION OF PREFERRED EMBODIMENT

A method for determining touch positions of the present invention is applicable in multimedia devices using resistive, capacitive, or optical touch technologies. The method is capable of determining touch positions based on single or multiple touch control points, and showing such touch positions on a touch display device by lines and/or graphics.

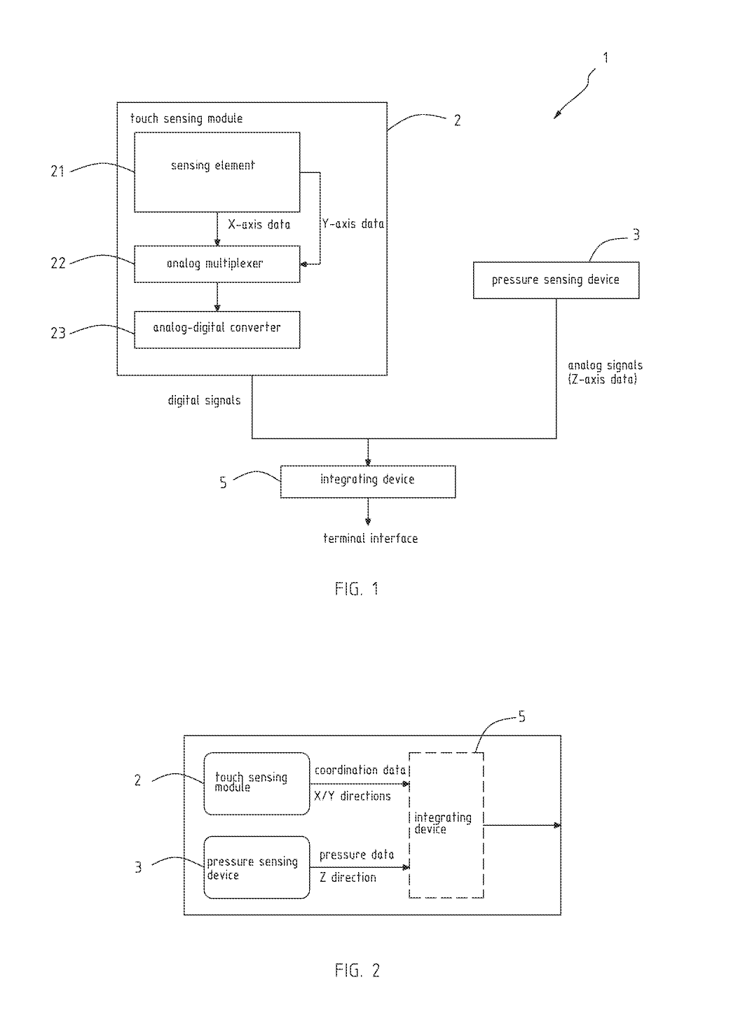

Referring to FIG. 1, it shows a schematic basic functional block diagram of a touch display device 1 of the present invention. The touch display device 1 comprises a touch sensing module 2, a pressure sensing device 3, and an integrating device 5. The touch sensing module 2 defines a touch area and comprises at least one sensing element 21, an analog multiplexer 22 and an analog-digital converter 23. The sensing element 21 is configured in accordance with different touch technologies.

With reference to FIG. 2, it shows a basic flowchart diagram of a method for determining touch positions of the present invention. The method mainly utilizes the sensing element 21 to sense X-axis and Y-axis positions of touched points within the touch area, and uses the pressure sensing device 3 to sense touch pressure so as to obtain Z-axis positions. Then, data of the X-axis, Y-axis and Z-axis positions is commonly integrated by the integrating device 5 to generate aggregated information which is applicable to handheld electronic devices as its terminal interfaces, such as cell phones or computers, etc.

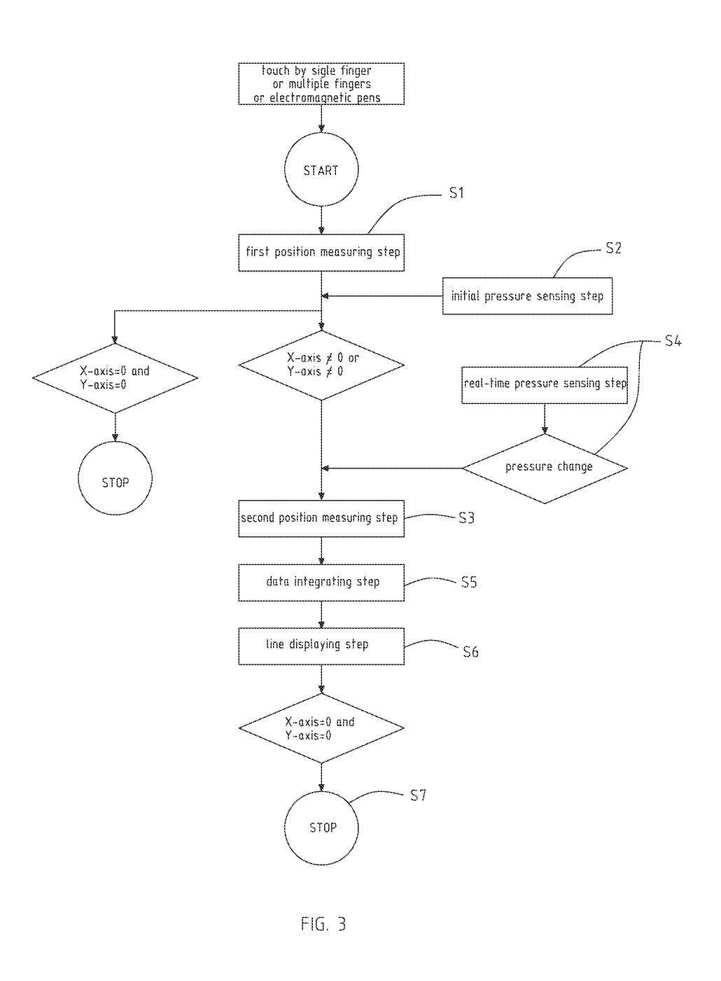

Refer to FIG. 3 which shows a detailed flowchart diagram of the method for determining touch positions of the present invention, the method is detailed described as followed:

A first position measuring step S1 of the method of the present invention is initiated by touching of a single finger, multiple fingers or electromagnetic pens in the touch area of a display panel. In the step S1, the at least one sensing element 21 of the touch sensing module 2 senses a first position of the touch area, and a control integrated circuit (IC) of the sensing element 21 computes to determine X-axis and Y-axis coordination values of the first position. Followed by an initial pressure sensing step S2, in the step S2, the pressure sensing device 3 senses touch pressure of the first position while the measured pressure value represents a corresponding Z-axis position of the first position. Thus, the X-axis, Y-axis and Z-axis positions in three dimensions are all available for the first position. Continuing with a second position measuring step S3, the at least one sensing element 21 senses if the first position has moved to a second position, in other words, senses if the first position has moved in either the X-axis or Y-axis direction. The control IC then calculates to determine X-axis and Y-axis coordination values of the second position after movement to the second position. Special attention should be paid here, when proceeding the step S3, a real-time pressure sensing step S4 is instantaneously executed. In the step S4, the pressure sensing device 3 senses a pressure change occurring during the movement from the first position to the second position and generates a corresponding pressure value in accordance with the pressure change. In other words, if any pressure different from the initial pressure occurs during the movement, the different pressure is instantaneously measured by the pressure sensing device 3. If the pressure remains same continuingly, the pressure of the second position is equal to in the one of the first position certainly.

Referring to FIG. 1 and FIG. 3, analog signals of the coordination values of the first and second positions are transmitted to the analog multiplexer 22 by the sensing element 21, and then further transmitted to the analog-digital converter 23 for conversion into digital signals. The initiate and instantaneous pressure values measured by the pressure sensing device 3 are also transmitted in form of analog signals. Ultimately proceeding to a data integrating step S5, the integrating device 5 integrates data of the first position, the second position, the initial pressure and the instantaneous pressure and produces aggregated information. The integrating device 5 comprises a drive circuit (not shown) electrically coupled to the pressure sensing device 3 and the touch sensing module 2. By means of the above, the method for determining touch positions of the present invention can not merely measure the X-axis and Y-axis coordination values of the first and second positions within the touch area, but also measure the initial and instantaneous pressure values by pressure sensing device 3 to obtain corresponding Z-axis positions respectively.

The aggregated information produced in the data integrating step S5 is analyzed in a line displaying step S6, and is displayed in the form of one line on the touch display device 1. A distance between the first and second positions represents a length of the displayed line, while the pressure difference between the first and second positions represents a width of the displayed line. The width of the displayed line varies according to the pressure change occurring between the first and second positions. In the present embodiment, the larger the pressure value is between the first and second positions, the greater the width of the displayed line is, while the smaller the pressure value is between the first and second positions, the smaller the width of the displayed line is.

Besides, when the touch sensing module 2 can not sense the first position or the second position, the X-axis and Y-axis coordination values of the first position or the second position are set as (0, 0), and the touch sensing module 2 stops sensing within the touch area in a stopping step S7 (Referring to FIG. 3).

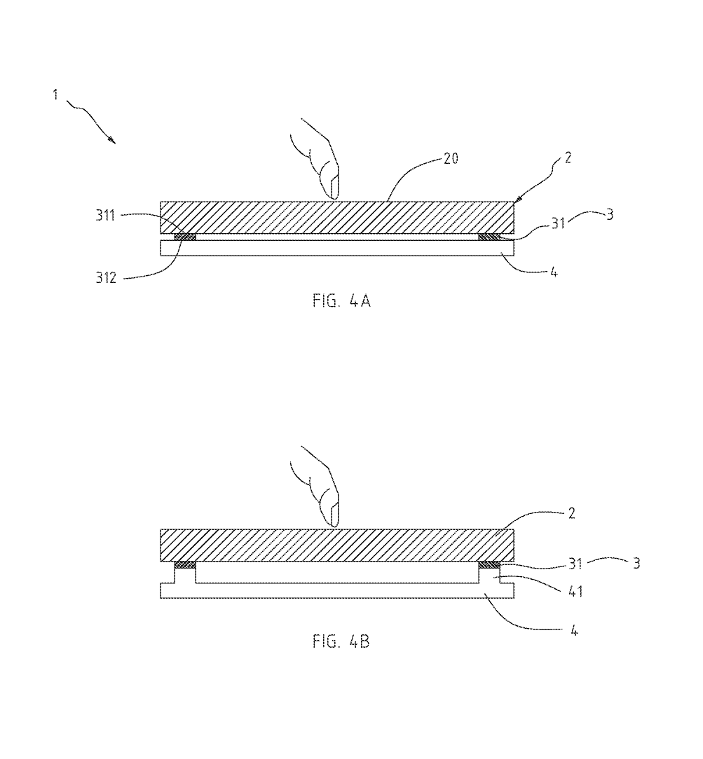

Referring to FIGS. 4A to 6C, they respectively show different embodiments of the touch display device 1 of the present invention. Firstly referring to FIGS. 4A and 4B, a first embodiment of the touch display device 1 is shown. As described above, the touch display device 1 comprises the touch sensing module 2 defining the touch area and comprising a touch screen 20, a plurality of the sensing elements 21, the analog multiplexer 22, and the analog-digital converter 23 (as shown in FIG. 1). The touch display device 1 also comprises a substrate 4 used to carry the touch sensing module 2, the pressure sensing device 3 installed between the touch sensing module 2 and the substrate 4, and the integrating device 5 (as shown in FIG. 1). The pressure sensing device 3 comprises a plurality of pressure sensing elements 31 each of which comprises an upper contact surface 311 and a lower contact surface 312. The integrating device 5 is electrically coupled to the touch sensing module 2 and the pressure sensing device 3. When the touch screen 20 is touch pressed by external articles such as fingers or electromagnetic pens, etc., the upper contact surface 311 of one of the plurality of pressure sensing elements 31 is activated with the touch pressure force while the lower contact surface 312 is activated with a reaction force from the substrate 4 so as to produce a corresponding pressure value. The plurality of pressure sensing elements 31 are made of piezoelectric material and are made in form of thin films. The plurality of pressure sensing elements 31 are dispersedly allocated around the touch sensing module 2, and directly attached on the touch sensing module 2 and the substrate 4. Continuingly referring to FIG. 4B, a mounting member 41 protrudes from the substrate 4 corresponding to a location of each of the plurality of pressure sensing elements 31 for support of the each pressure sensing element 31.

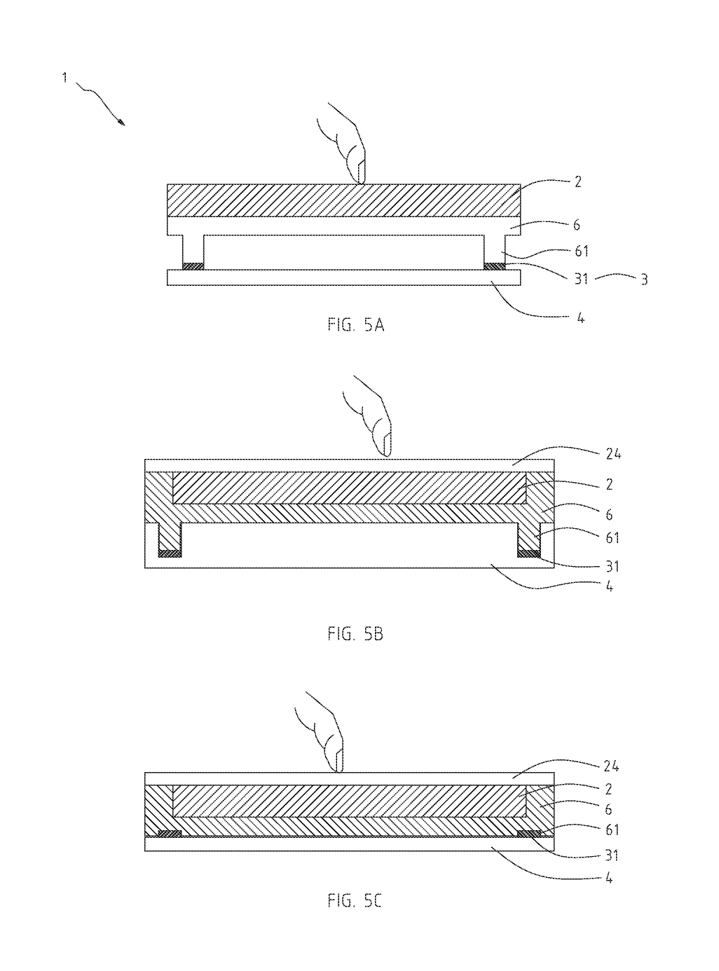

Referring to FIGS. 5A to 5C, a second embodiment of the touch display device 1 of the present invention is shown. A carrier 6 is further connected beneath the touch sensing module 2 in FIG. 5A to directly carry the touch sensing module 2. A mounting member 61 protrudes from the carrier 6 corresponding to each of the plurality of pressure sensing elements 31 to pressingly engage the each pressure sensing element 31. Referring to FIG. 5B, a transparent screen 24 is installed on the touch sensing module 2 to be used as a contact surface for touching. The mounting member 61 protrudes from the carrier 6 while a groove is additionally formed on the substrate 4 corresponding to the mounting member 61 to receive the mounting member 61. Referring to FIG. 5C, the mounting member 61 of the carrier 6 is made to concave from an outer surface of the carrier 6 to install the each pressure sensing element 31.

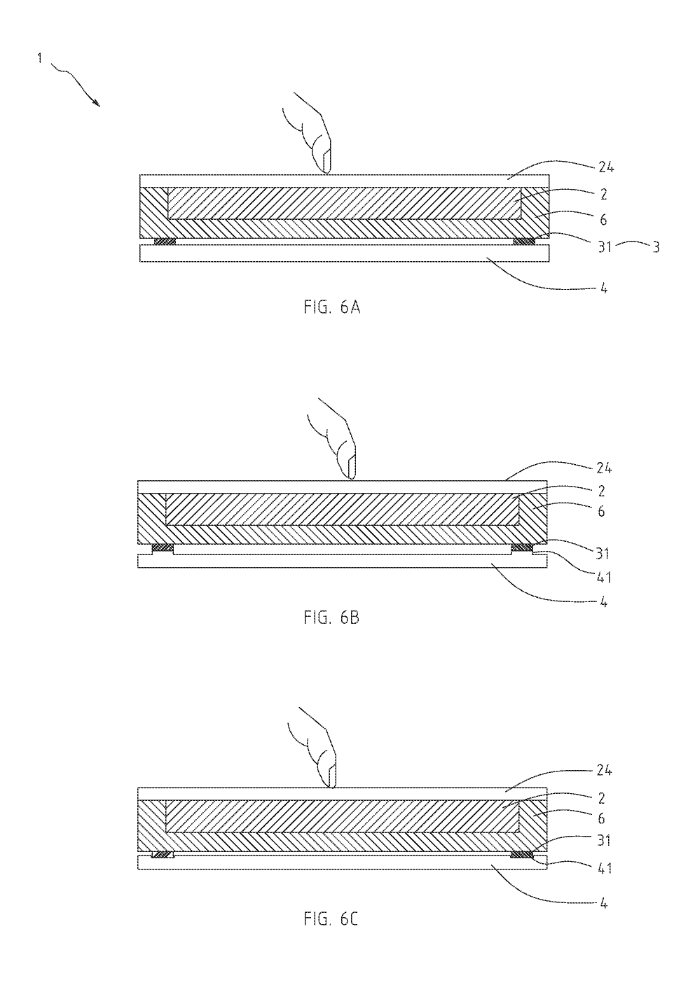

Referring to FIGS. 6A to 6C, a third embodiment of the touch display device 1 of the present invention is shown. As shown in FIG. 6A, no additional mounting member 61 or 41 is installed on the carrier 6 or the substrate 4. The plurality of pressure sensing elements 31 are directly attached between the carrier 6 and the substrate 4. Referring to FIG. 6B, the mounting member 41 further protrudes from the substrate 4 to support the corresponding touch sensing element 31. At last referring to FIG. 6C, the mounting member 41 of the substrate 4 is concaved from an outer surface of the substrate 4 to install the corresponding pressure sensing element 31. To sum up, the configuration of the touch display device 1 may vary in different embodiments, the pressure sensing device 3 thereof is completely capable of being activated with the touch pressing forces and reaction forces generated by touch control, and capable of providing corresponding pressure values so as to use their corresponding Z-axis positions to present three dimensional features thereof and to display width of lines.

Conclusively as above, the method for determining touch positions of the present invention can present changes in thickness of displayed lines so as to meet using requirements of writing, text shapes or drawing. Lines with different thickness are presented in accordance with users' touch pressure so as to reach performance same as traditional pens and paper.

Although the present invention has been described by the above detailed illustrations merely with reference to the preferred embodiments thereof, it is apparent to those skilled in the art that a variety of modifications and changes may be made without departing from the scope of the present invention which is intended to be defined by the appended claims.

What is claimed is:

1. A touch measuring method adapted to sense and determine touch positions of a touch display device, comprising:
a first position measuring step for sensing a first position in a touch area by a touch sensing module to determine X-axis and Y-axis coordination values of the first position;
an initial pressure sensing step for sensing an initial pressure of the first position by a pressure sensing device;
a second position measuring step for sensing if the first position has moved to a second position and determining X-axis and Y-axis coordination values of the second position by the touch sensing module;
a real-time pressure sensing step for sensing a pressure change during the movement from the first position to the second position by the pressure sensing module, and generating a corresponding pressure value based on the pressure change being sensed as an instantaneous pressure; and
a data integrating step for integrating data of the first position, the second position, the initial pressure and the instantaneous pressure by an integrating device having a drive circuit, and producing aggregated information thereof.

2. The touch measuring method as claimed in claim 1, wherein the touch sensing module comprises at least one sensing element, an analog multiplexer and an analog-digital converter, the coordination values of the first and second positions are sensed by the at least one sensing element, and analog signals from the at least one sensing element are transmitted to the analog multiplexer, the analog-digital converter receives the analog signals and converts to digital signals.

3. The touch measuring method as claimed in claim 2, wherein the data integrating step is intended for integrating the digital signals transmitted from the touch sensing module, and analog signals transmitted from the pressure sensing device so as to generate the aggregated information.

4. The touch measuring method as claimed in claim 1, further comprising a line displaying step for analyzing the aggregated information generated by the data integrating step and correspondingly displaying in form of a line on the touch display device, wherein a distance between the first and second positions represents a length of the line, a pressure value between the first and second positions represents a width of the line, and the width of the line varies according to the sensed pressure changed between the first and second positions.

5. The touch measuring method as claimed in claim 4, wherein the width of the line is greater when the pressure value between the first and second positions is larger, and the width of the line is smaller when the pressure value between the first and second positions is smaller.

6. The touch measuring method as claimed in claim 1, wherein when the touch sensing module is unable to sense the first position or the second position, the X-axis and Y-axis coordination values of in the first position or the second position is set as (0,0), and the touch sensing module stops sensing within the touch area.

7. A touch display device, comprising;
a touch sensing module defining a touch area, and comprising a touch screen, at least one sensing element, an analog multiplexer and an analog-digital converter, the at least one sensing element used for sensing touch positions within the touch area;
a substrate for carrying the touch sensing module;
a pressure sensing device installed between the touch sensing module and the substrate, and comprising at least one pressure sensing element having an upper contact surface and a lower contact surface to respectively bear touch a pressing force and a reaction force thereof to generate a corresponding pressure value; and
an integrating device comprising a drive circuit, and electrically coupled to the pressure sensing device and the touch sensing module, the integrating device integrating data signals transmitted from the touch sensing module and the pressure sensing device, and produce aggregated information.

8. The touch display device as claimed in claim 7, wherein the at least one pressure sensing element comprises plural ones, and is made of piezoelectric material and is dispersedly installed on a side of the substrate corresponding to the touch sensing module.

9. The touch display device as claimed in claim 7, wherein a carrier is further connected to a side of the substrate corresponding to the touch sensing module, the carrier comprises at least one mounting member either protruding out or being recessed from an outer surface of the carrier to install the at least one pressure sensing element.

10. The touch display device as claimed in claim 7, wherein the at least one mounting member is disposed at a side of the substrate corresponding to the touch sensing module, the at least one mounting member protrudes out or is recessed from the outer surface of the substrate to install the at least one pressure sensing element.
